(19) United States
(12) Patent Application Publication
(10) Pub. No.: US 2013/0138635 A1
(43) Pub. Date: May 30, 2013

(54) SEARCH METHOD USING A PLURALITY OF SPACE OF INTEREST OBJECTS

(71) Applicants: Cheol-Woo Park, Seoul (KR); Soon-Sung Kwon, Anyang (KR); Hong-Hoi Kim, Daejeon (KR)

(72) Inventors: Cheol-Woo Park, Seoul (KR); Soon-Sung Kwon, Anyang (KR); Hong-Hoi Kim, Daejeon (KR)

(73) Assignee: HYUNDAI MOTOR COMPANY, Seoul (KR)

(21) Appl. No.: 13/617,967

(22) Filed: Sep. 14, 2012

Related U.S. Application Data
(63) Continuation-in-part of application No. 13/320,649, filed on Nov. 15, 2011.
(60) Provisional application No. 61/591,192, filed on Jan. 26, 2012.

(30) Foreign Application Priority Data
May 15, 2009 (KR) 10-2009-0042401

(51) Int. Cl. G06F 17/30

(52) U.S. Cl. CPC G06F 17/30424
USPC 707/723; 707/769

(57) ABSTRACT

One aspect of the invention provides a method of searching using two or more space of interest (SOI) objects. The method includes: selecting two or more SOI objects; and performing a search using a search method within the two or more selected SOI objects. Another aspect of the invention provides a method of searching using two or more space of interest (SOI) objects. The method includes: selecting two or more SOI objects, wherein selecting two or more SOI objects comprises selecting an individual SOI object or a sub SOI object of another SOI object; performing a search using a search method for the two or more selected SOI objects, wherein the search method comprises a method of multiple searching for all of the two or more SOI objects; and determining a prioritization of results from the search by applying a weight to the results from the search.

### CROSS-REFERENCE TO RELATED APPLICATIONS

This application claims priority under 35 U.S.C.

§119(e) to U.S. Provisional Patent Application Ser. No. 61/591,192, filed Jan. 26, 2012. This application is also a continuation-in-part under 35 U.S.C. §120 of U.S. patent application Ser. No. 13/320,649, filed Nov. 15, 2011, which is a national phase application under 35 U.S.C. §371 of International Application No. PCT/KR2010/003055, filed May 14, 2010, which claims priority to Korean Patent Application No. 10-2009-0042401, filed May 15, 2009. The entire content of each of the above-referenced patent applications is hereby incorporated by reference herein.

### FIELD OF THE INVENTION

The present invention relates to a search method using a plurality of space of interest objects, using a location based data that uses a space of interest (SOI) as a unit.

### BACKGROUND OF THE INVENTION

Generally, location based data using a point of interest (POI) uses a certain point that is represented by XY coordinates as a unit. In the location information service using POI data, when searching for a specific location, only a certain point corresponding to the coordinates (e.g., in a search for a specific building, coordinates of the building's entrance are displayed) are displayed, so that the area of the space represented by the point and facilities within the area of the space cannot be represented exactly.

### SUMMARY OF THE INVENTION

The present invention overcomes the above problems and provides a search method using a plurality of SOI objects to solve a limitation that a searching scope cannot be confined to a specific space (area) because POI exists as a point, and thus, it cannot represent a space or an area. An SOI object refers to a structure that binds spatial information, identifying data and property information (e.g., color, thickness of line, type of line, time of exposure, allowed time of use, control of permission to access) of an SOI.

Namely, the present invention has an object to implement “a conditional search” for a selected space by selecting a plurality of SOIs as well as a single SOI in a location based service using an SOI as a unit that represents a space.

One aspect of the invention provides a method of searching using two or more space of interest (SOI) objects. The method includes: selecting two or more SOI objects; and performing a search using a search method within the two or more selected SOI objects.

The method can further include determining a prioritization of results from the search by applying a weight to the results from the search.

In another embodiment, selecting two or more SOI objects comprises selecting an individual SOI object or a sub SOI object of another SOI object.

In another embodiment, each of the two or more SOI objects has a different SOI identifier.

In another embodiment, each of the two or more SOI objects has a different SOI identifier.

In another embodiment, the search method comprises a method of searching in series within each of the two or more SOI objects.

In another embodiment, the search method comprises a method of searching in series within each of the two or more SOI objects.

In another embodiment, the search method comprises a method of simultaneously searching in parallel within each of the two or more SOI objects.

In another embodiment, the search method comprises a method of simultaneously searching in parallel within each of the two or more SOI objects.

In another embodiment, the search method includes conducting a multiple search of all of the two or more SOI objects.

In another embodiment, the search method includes conducting a multiple search of all of the two or more SOI objects.

In another embodiment, the weight is calculated in consideration of a weight for contents of the SOI and a weight for a relation of the SOI.

In another embodiment, the weight for the contents of the SOI is calculated by considering one or more factors.

In another embodiment, the weight for contents of the SOI is calculated by considering one or more factors selected from the group consisting of: reliability of the search result, term frequency-inverse document frequency (TF-IDF), an absolute priority, a type of contents, a source of contents, and popularity.

In another embodiment, the weight for the relation of the SOI is calculated by considering one or more relations selected from the group consisting of: a vertical relationship structure, a horizontal relationship structure, and a combined relationship structure.

Another aspect of the invention provides a method of searching using two or more space of interest (SOI) objects. The method includes: selecting two or more SOI objects, wherein selecting two or more SOI objects comprises selecting an individual SOI object or a sub SOI object of another SOI object; performing a search using a search method for the two or more selected SOI objects, wherein the search method comprises a method of multiple searching for all of the two or more SOI objects; and determining a prioritization of results from the search by applying a weight to the results from the search.

Another aspect of the invention provides a method of searching using a plurality of space of interest (SOI) objects. The method includes: selecting the plurality of SOI objects; performing a search using a search method for the plurality of selected SOI objects; and determining a prioritization of results from the search by applying a weight to the results from the search. The SOI object has a vertical relationship structure, a horizontal relationship structure, or a combined relationship structure with an another SOI object, or exist alone without a relationship structure.

In one embodiment, selecting the plurality of SOI objects comprises selecting an individual SOI object or a sub SOI object of another SOI object.

In another embodiment, the search method includes performing multiple searching for all of the plurality of SOI objects.

### BRIEF DESCRIPTION OF THE DRAWINGS

The objects, features, and advantages of the present invention will be more apparent from the following detailed description in conjunction with the accompanying drawings, in that:

FIGS. 1a to 1c are block diagrams illustrating a vertical relationship structure, a horizontal relationship structure, and a combined relationship structure according to an exemplary embodiment of the present invention;

FIG. 2 is an exemplary screenshot of a search method according to an exemplary embodiment of the present invention;

FIG. 3 is a block diagram illustrating a system to implement a search method according to an exemplary embodiment of the present invention;

FIG. 4 is a flowchart illustrating a search method according to an exemplary embodiment of the present invention; and

FIG. 5 depicts a network having a generalized topography in which aspects of the invention can be implemented.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

For a location based data search, a concept of space of interest (“SOI”) was introduced. A space of interest (SOI) refers to a collection of data about a space of people's interest or use. An SOI is made up of point, line and/or plane and has a unique identifying data.

A conventional location information service simply searches for a name of a space such as the name of a specific building as it is typed in the search engine box, and a map displaying a corresponding point is outputted to a user as a search result. Namely, simply only coordinates of the corresponding POI can be searched and outputted. Also, in a search for a specific POI, although the associated place (e.g., facilities within the building) is displayed, it is simply listed on the map or beside the map.

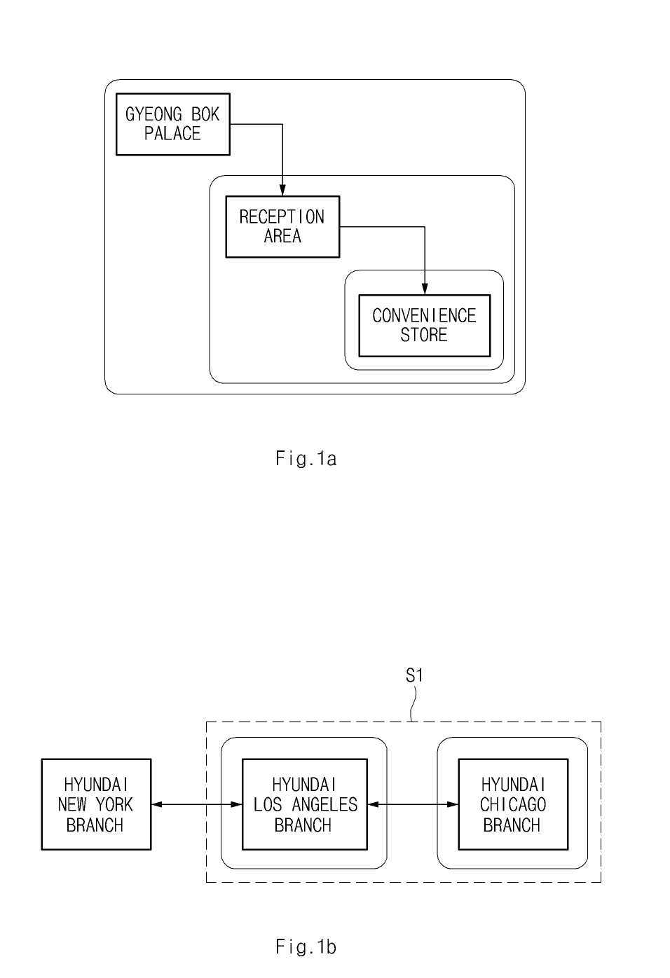

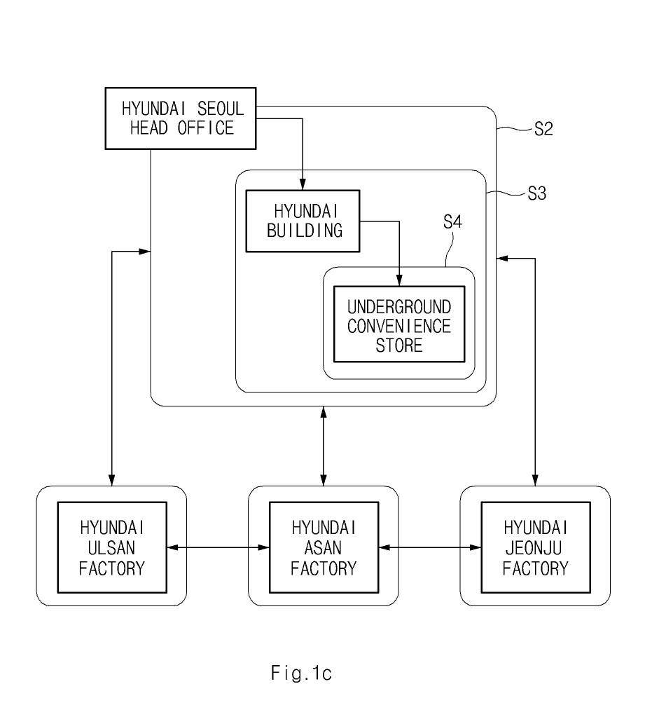

FIGS. 1a to 1c are block diagrams illustrating a vertical relationship structure, a horizontal relationship structure, and a combined horizontal and vertical relationship structure according to an exemplary embodiment of the present invention.

FIG. 1a shows a vertical relationship structure that an SOI object of Gyeongbok Palace contains a reception area and a convenience store within the SOI of Gyeongbok Palace as “sub SOIs”. FIG. 1b shows a horizontal relationship structure that exists between a plurality of objects without any sub SOIs. FIG. 1c shows a combined relationship structure, that combines the vertical relationship structure of FIG. 1a and the horizontal relationship structure of FIG. 1b.

FIG. 1a shows that an SOI object can have at least one or more sub SOI objects. As an exemplary embodiment, Gyeongbok Palace has a reception area that is included in Gyeongbok Palace as a sub SOI object, and the convenience store that is in the reception area can be the sub SOI object of the reception area. Thus, each of the SOI objects hierarchically can form a vertical relationship structure including the location (object), that is actually included within the space.

FIG. 1b shows a horizontal relationship structure without hierarchy. For example, Hyundai New York branch, Hyundai Los Angeles branch and Hyundai Chicago branch can be associated with a Hyundai dealership. However, each of these branches does not have one or more branch of their own within their branches, but they rather coexists as SOI objects, thereby forming a horizontal relationship structure. As an exemplary embodiment, in this horizontal relationship structure, a higher or a broader SOI object (S1) including at least one more object can be created. If two or more SOI objects can be tied in common in the horizontal relationship structure, a higher or broader object (S1) can be assigned as one object, thereby improving convenience of management.

FIG. 1c is a block diagram showing a combined relationship structure wherein a mixture of the vertical relationship structure and the horizontal relationship structure are used. For instance, as shown in FIG. 1c, Hyundai Seoul head office includes a Hyundai building within its space, and the Hyundai building includes an underground convenience store within its space, thereby forming a hierarchical vertical relationship structure. However, the S2 object showing the Seoul head office can form a horizontal relationship structure with Hyundai factories in a number of cities.

As shown in FIG. 1a through FIG. 1c, the SOIs can be represented by a variety of relationship structures. Throughout the present invention, with SOI objects that have these features, performing a search selecting two or more SOI objects according to various methods is possible.

For example, when a user tries to search for a specific object, the object of the search can be uncertain, for instance, whether it is in Hyundai Seoul head office or in Hyundai Ulsan factory. Conventionally, in this case, a search for Hyundai Seoul head office and a search for Hyundai Ulsan factory had to be performed separately.

However, to overcome this limitation, the present invention can provide a search method that allows for the selection two or more SOI objects, and performs a search within the selected SOI objects. In this example, a user can choose an identifier for SOI (SOI ID) for both Hyundai Seoul head office (S2) and Hyundai Ulsan factory, and a search for a confined space can be carried out.

In addition, in the present invention, using the characteristics of an SOI object, more detailed search can be performed by not only simply performing a search within the designated two or more spaces but also allowing a search within a sub SOI of a specific SOI object and other SOI objects. For example, in FIG. 1c, a user can set the underground convenience store (S4) and Hyundai Jeonju factory as a search range.

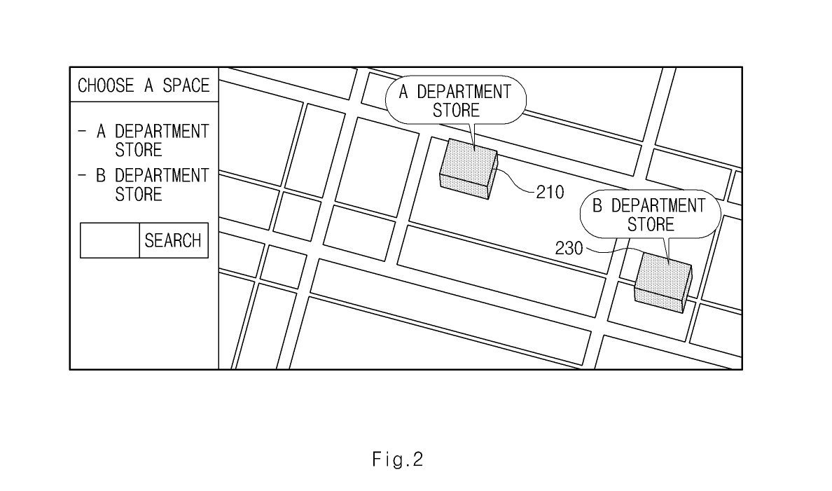

FIG. 2 is an exemplary screenshot of the search method according to an exemplary embodiment of the present invention. For example, a user tries to search for a Korean restaurant in both A department store and B department store. The user can choose A department store 210 and B department store 230 on the map. At this time, A department store 210 and B department store 230 are implemented as location based service using an SOI object unit, so that, as shown in FIG. 2, they can be chosen as a space not as a point.

When the user chooses A department store 210 and B department store 230, it can be set so that the only space that is automatically selected is to be searched. Once the space to search is set, the user enters a search word, then the system that receives the input can perform searching. When A department store 210 has a Korean restaurant (A1), and B department store 230 has two Korean restaurants (B1, B2), a total of three restaurants would result from the search.

Here, a variety of methods can be applied in how to perform a search. As an exemplary embodiment, in the example above, the search for each of A department store and B department store can be performed in a serial manner. As another exemplary embodiment, a parallel search for each of A department store and B department store can be performed at the same time (i.e., in parallel). The SOI structures can be traversed such that each sub-SOI of a selected SOI is searched in accordance with various known tree traversal algorithms.

As another exemplary embodiment, when A department store and B department store are selected, certain selected sub SOIs for A department store and B department store can be collected before the search is performed. Namely, a single “multiple search” of two or more SOI objects can be performed rather than individual (traversing) searches of each of the selected two or more SOI objects.

Therefore, the search can be a search for each of the plurality of objects or multiple searching for all of the plurality of objects. In case of performing the multiple searching, an improved effect in terms of time efficiency can be expected than in case of performing an individual (traversing) search for each of the plurality of objects.

As an exemplary embodiment, when displaying a search result, the present invention determines the priorities of the search results by applying a certain weight. The weight can include, for example, the weight for content (e.g., the weight considering reliability of search result, popularity, contents type and contents sources etc.) and the weight for an SOI relation (e.g., the weight of a vertical relationship structure, a horizontal relationship structure and a combined relationship structure). For example, when the popularity of A1 Korean restaurant is very high, the weight for popularity is applied, and the value of weight of the search result can be calculated by applying a level that depends on that type of relationship structure A1 restaurant has with A department store. Namely, the weight for contents is applied by evaluating the popularity, the reliability of the search result, the contents type and/or the contents sources. The weight for SOI relationship structure is applied according to the determined relationship upon setting different weight levels that depend on the vertical relationship structure, the horizontal relationship structure, and the combined relationship structure.

The value of weight can be calculated, applying the weight for contents and the weight for SOI relation to each of the search results. After calculating the weighted value of each of the search results, priority of displaying of the search results can be determined comparing the values in ascending order (or descending order).

In other words, these search results determined in this priority can have high popularity or high reliability, and these are derived from considering the relation with the SOI object as assigned by the user. For example, when searching for a Korean restaurant, a typical user probably intends to search for a popular restaurant, therefore outputting the search results in order of popularity may be desirable. In addition, when assuming that the result having a vertical SOI relationship structure is more accurate rather than the result having a horizontal relationship structure, the result having a vertical relationship structure can be outputted by applying a greater weight.

In calculating the value of weight, applying other types of weight is possible.

A conventional search was merely to write a search expression or perform a search within the result. However, by using the search method of the present invention, a user can perform the search within an SOI or SOIs that can be selected by the user on the map before the search, which makes it more convenient for a user. Also, the search result is prioritized according to the weight, by reflecting the user's search intent, and by considering the accuracy of the search rather than merely listing the search list, and thus, the search results of the present invention better satisfies the user's needs than the conventional search.

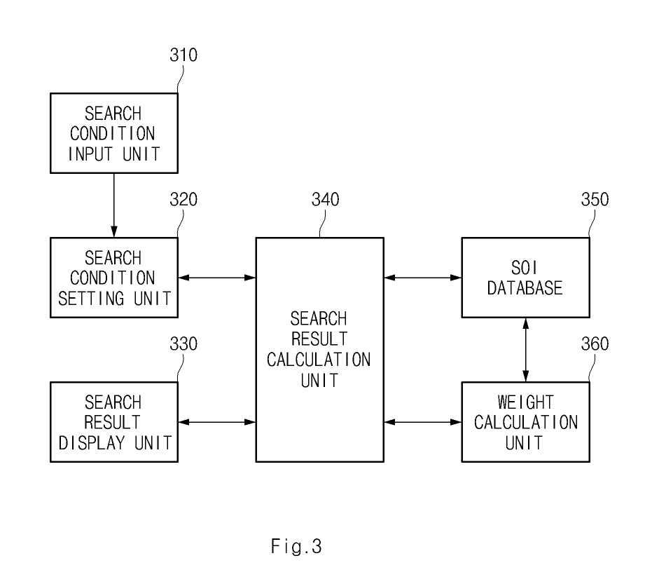

FIG. 3 is a block diagram illustrating a system to implement a search method according to an exemplary embodiment of the present invention.

The search system of the present invention can include a search condition input unit 310, a search condition setting unit 320, a search result display unit 330, a search result calculation unit 340, a SOI database 350, and a weight calculation unit 360. The search system of performing a search method according to the present invention can be implemented, for example, as a server form, and the components of this system can be implemented as a separate form even though the present invention is illustrated as a single device.

The search condition input unit 310 can recognize designating a space to search by selecting a specific space object, and deliver the entered information. The search condition input unit can receive the input in conjunction with an input device such as a pointing device.

The search condition setting unit 320 can set a search condition according to the given method, with reference to the information received from the search condition input unit 310. Here, the given method can include a method of performing an individual search several times for each of the two or more selected SOI objects or a method of performing a multiple search for all of the two or more selected SOI objects in searching. The method of the individual search can include searching the selected objects in order (in series) or simultaneously in parallel. The search condition setting unit can be set to apply at least one or more of the search method to the received input information. Also, this search method can be set to be applied differently depending on the received input information.

The search result calculation unit 340 derives the search result. It can detect the search result, using an SOI database 350 with reference to the search condition. Here, the search result calculation unit that is in conjunction with the weight calculation unit 360 can determine the prioritization of the search results, applying a certain weight in advance to the search results obtained from the SOI database 350.

The weight calculation unit 360 can include a weight for contents of an SOI and a weight for relation of an SOI. The weight for contents of the SOI can include, for example, the popularity of the contents, the reliability (e.g., reliability considering similarity of search result and accuracy) of the search results, a term frequency-inverse document frequency (TF-IDF), an absolute priority, a type of contents, and the source of contents, or the like. The weight for relation of the SOI can include weight depending on the type of relationship structure of the SOI, i.e., vertical relationship structure, horizontal relationship structure, and combined relationship structure. The weight for relation can be set as a different value depending on the type of the relationship structures, and it also can be set to be expressed as a different value according to the degree of the relation.

After the prioritization is determined by applying the weight, the search result calculation unit 340 can provide search results to the search result display unit 330. The search result display unit 330 can perform outputting the received search results according to the prioritization. The displaying of the search results can be displayed in various ways, for example, in the form of an image on the map, or in the form of a text, or the like.

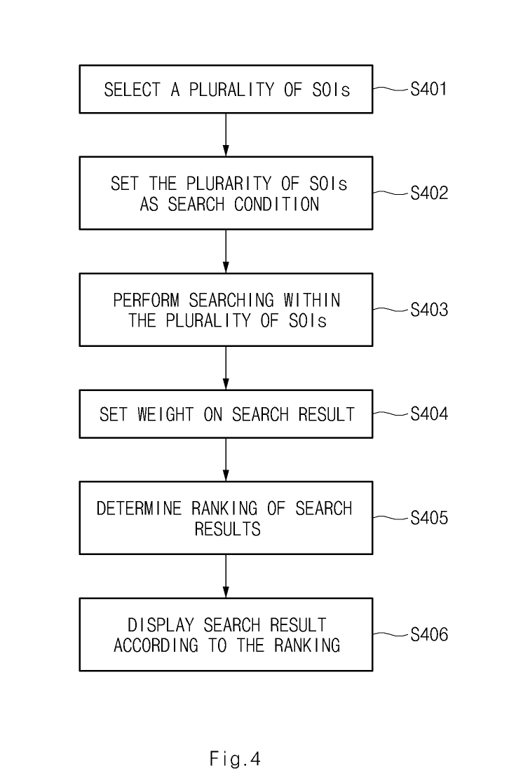

FIG. 4 is a flowchart illustrating a search method according to an exemplary embodiment of the present invention.

In the search system according to an exemplary embodiment of the present invention, a plurality of SOI objects can be selected depending on the user's input (S401). As shown in FIG. 2, two or more buildings and places (i.e. SOIs) can be selected, and the number of the SOI objects can be counted based on the SOI ID. Namely, when a specific SOI has multiple sub SOI objects, the SOI is regarded as one and the SOI ID of the sub SOI object is not to be selected when selecting the specific SOI object.

When a plurality of SOIs are selected, the plurality of SOI objects can be set as a search condition (S402). Namely, an individual search or a multiple search can be designated to be performed within the selected SOI objects. When the search condition is set, the search within the set SOI objects is performed according to the user's input of a search word (S403).

The search method, as described above, can include a method of performing an individual search for each of the two or more selected SOI objects search several times or a method of performing a multiple search for all of the selected SOI objects. The method of the individual search can include searching each of the selected objects in series or simultaneously in parallel. The multiple searching can be effectively used in case of an increase in Internet traffic that causes trouble in searching as the search query can be reduced in a multiple searching compared with the individual searching.

The search can be performed on the SOI database 350 to detect search results. When the search results are detected, a certain weight can be applied for the search results (S404). Applying the weight is done to obtain search results that have taken into consideration the user's intent and the accuracy of the search.

If each of the search results has a value of weight as a result of applying a certain weight to the search results, the prioritization is determined according to the value of the weight (S405). As an exemplary embodiment, the prioritization can be determined by using a prioritization method (i.e. ranking algorithm) that is used in a conventional search system (S406). As another exemplary embodiment, the results can be obtained using with a variety of prioritizations according to a classification (i.e., categories like distance, popularity, etc.)

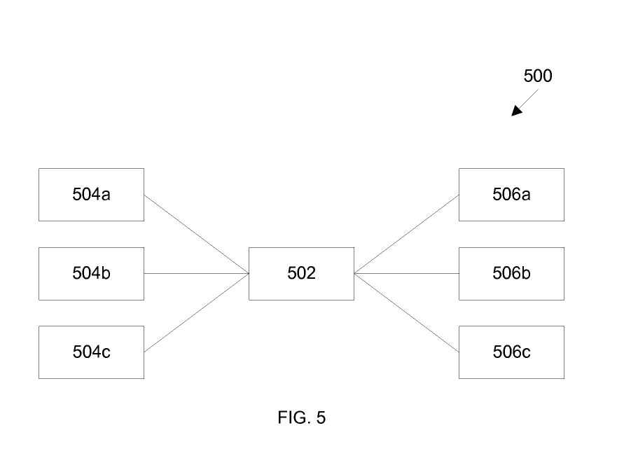

Referring now to FIG. 5, the aspects and embodiments of the invention described herein can be implemented in a variety of embodiments including a network having a generalized topography 500. Network can, for example, include one or more general-purpose computers 502 programmed according to the disclosure herein to store and process SOI information.

This SOI information can, for example, be generated using the same or different general-purpose computers 504. For example, a property owner, business owner, or other interested user can utilize computer 504 to generate or modify information relating to SOI, content, themes, etc. The user can, for example, submit this information via a specially-programmed client program that is installed on computer 504 or communicate with computer 502 via one or more Web pages displayed on an Internet browser on computer 504.

One or more end users can access information regarding SOI, content, themes, etc. through a variety of devices 506 such as general-purpose computers (e.g., computers including network connections and Internet browsers), mobile telephones, smart phones (e.g., smart phones sold under the IPHONE® trademark by Apple Inc. of Cupertino, Calif.), tablets (e.g., tablets sold under the IPAD® trademark by Apple Inc. of Cupertino, Calif.), and the like. In still another embodiment, device 506 can be a navigation or global positioning system that can be carried by a user or mounted in a motor vehicle (e.g., a car, truck, airplane, or boat) either during original assembly of the vehicle or post-sale.

Computer 502 can include one or more memory and/or storage devices that can store computer program instructions and/or data. For example, SOI information and associated data can be stored in a database management system (DBMS) that implements a database. The database can be a relational database such as a SQL database. In such an embodiment, each category of data (e.g., SOI, content, etc.) can be stored in a separate table in which a unique ID for each datum can serve as a key. Relationships between data (e.g., SOI-content, SOI-SOI, content-content) can be represented by a data entry in still another table that includes an ID for the related data.

Devices 502, 504, 506 can be operated through the execution of instructions stored on a computer readable medium. A “computer readable medium” shall be understood to mean any article of manufacture that contains data that can be read by a computer or a carrier wave signal carrying data that can be read by a computer. Such computer readable media includes, but is not limited to, magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

The present invention has been particularly shown and described in detail with the exemplary embodiments thereof, so, the components, their connection and relationship, and their functions herein mean only exemplary. In the present invention, it is shown that the components (310, 320, 330, 340, 350, 360) are physically united, but each of the components can be physically separated or integrated in the form of one or more components according to need.

The method suggested by the present invention can overcome the limitation of a POI search and set a detailed SOI object and a plurality of SOI objects as a search condition, thereby the accuracy of the search can be improved and the requirement of user can be satisfied.

Although exemplary embodiments of the present invention have been described in detail hereinabove, it should be clearly understood that many variations and modifications of the basic inventive concepts herein taught that may appear to those skilled in the present art will still fall within the spirit and scope of the present invention, as defined in the appended claims.

What is claimed is:

1. A method of searching using two or more space of interest (SOI) objects, the method comprising:
selecting two or more SOI objects; and
performing a search using a search method within the two or more selected SOI objects.

2. The method of claim 1, further comprising:
determining a prioritization of results from the search by applying a weight to the results from the search.

3. The method of claim 1, wherein selecting two or more SOI objects comprises selecting an individual SOI object or a sub SOI object of another SOI object.

4. The method of claim 1, wherein each of the two or more SOI objects has a different SOI identifier.

5. The method of claim 3, wherein each of the two or more SOI objects has a different SOI identifier.

6. The method of claim 1, wherein the search method comprises a method of searching in series within each of the two or more SOI objects.

7. The method of claim 3, wherein the search method comprises a method of searching in series within each of the two or more SOI objects.

8. The method of claim 1, wherein the search method comprises a method of simultaneously searching in parallel within each of the two or more SOI objects.

9. The method of claim 3, wherein the search method comprises a method of simultaneously searching in parallel within each of the two or more SOI objects.

10. The method of claim 1, wherein the search method includes conducting a multiple search of all of the two or more SOI objects.

11. The method of claim 3, wherein the search method includes conducting a multiple search of all of the two or more SOI objects.

12. The method of claim 2, wherein the weight is calculated in consideration of a weight for contents of the SOI and a weight for a relation of the SOI.

13. The method of claim 2, wherein the weight for the contents of the SOI is calculated by considering one or more factors.

14. The method of claim 2, wherein the weight for contents of the SOI is calculated by considering one or more factors selected from the group consisting of: reliability of the search result, term frequency-inverse document frequency (TF-IDF), an absolute priority, a type of contents, a source of contents, and popularity.

15. The method of claim 2, wherein the weight for the relation of the SOI is calculated by considering one or more relations selected from the group consisting of: a vertical relationship structure, a horizontal relationship structure, and a combined relationship structure.

16. A method of searching using two or more space of interest (SOI) objects, the method comprising:
selecting two or more SOI objects, wherein selecting two or more SOI objects comprises selecting an individual SOI object or a sub SOI object of another SOI object;
performing a search using a search method for the two or more selected SOI objects, wherein the search method comprises a method of multiple searching for all of the two or more SOI objects; and
determining a prioritization of results from the search by applying a weight to the results from the search.

17. A method of searching using a plurality of space of interest (SOI) objects, the method comprising:
selecting the plurality of SOI objects;
performing a search using a search method for the plurality of selected SOI objects; and
determining a prioritization of results from the search by applying a weight to the results from the search,
wherein the SOI object has a vertical relationship structure, a horizontal relationship structure, or a combined relationship structure with an another SOI object, or exist alone without a relationship structure.

18. The method of claim 17, wherein selecting the plurality of SOI objects comprises selecting an individual SOI object or a sub SOI object of another SOI object.

19. The method of claim 17, wherein the search method includes performing multiple searching for all of the plurality of SOI objects.
